(19) United States
(12) Patent Application Publication
(10) Pub. No.: US 2024/0382972 A1
(43) Pub. Date: Nov. 21, 2024

(54) MANTLE FOR A GYRATORY OR CONE CRUSHER

(71) Applicant: METSO FINLAND OY, Espoo (FI)

(72) Inventor: Mikko MALKAMAKI, Vantaa (FI)

(73) Assignee: METSO FINLAND OY, Espoo (FI)

(21) Appl. No.: 18/576,840

(22) PCT Filed: Jul. 4, 2022
(86) PCT No.: PCT/EP2022/068411

§ 371 Date: Jan. 5, 2024

(30) Foreign Application Priority Data
Jul. 7, 2021 (EP) 21184234.9

(51) Int. Cl. B02C 2/04

(52) U.S. Cl. CPC B02C 2/04; B02C 2210/02

(57) ABSTRACT

A mantle for a gyratory or cone crusher that includes a frame having a bowl as a first crushing shell, and a crusher head including the mantle as a second crushing shell, wherein the mantle and bowl define a crushing gap between them. The mantle includes a central axis, a first end and a second end along the central axis, and an outer peripheral surface defined by a generatrix rotating around the central axis. The outer peripheral surface constituting a crushing surface of the mantle, and an outer diameter of the mantle being larger at the second end than at the first end. One or more grooves are formed in the crushing surface at the second end of the mantle, and one or more cavities for receiving wear resistant inserts are formed in the crushing surface. One or more wear resistant inserts are bonded to or into the crushing surface.

### FIELD OF THE INVENTION

The present invention relates to a mantle for a gyratory or cone crusher, and to a gyratory or cone crusher comprising the mantle.

Gyratory crushers and cone crushers are two types of rock crushing systems which generally break apart rock, stone or other material in a crushing gap between a stationary element and a moving element.

A gyratory or cone crusher is comprised of a head assembly including a crusher head that gyrates about a vertical axis within a stationary bowl attached to a main frame of the rock crusher. The crusher head is assembled surrounding an eccentric that rotates about a shaft to impart the gyratory motion to the crusher head which crushes rock, stone or other material as the material travels through a crushing chamber or crushing gap between the crusher head and the bowl. The crushed material exits the crusher through the bottom of the crushing gap.

While gyratory crushers and cone crushers operate according to the same principles, the longer shaft or spindle of a gyratory crusher regularly has its upper end supported by a spider bearing, whereas the shorter spindle of the cone crusher is not suspended but supported in a bearing below the gyratory head or cone. Gyratory crushers are often used as primary crushers, i.e. heavy-duty machines designed to process large material sizes. Secondary and tertiary crushers are intended to process relatively smaller feed materials. Cone crushers are often utilised as downstream crushers.

### PRIOR ART

Gyratory and cone crushers utilize wear parts to protect the machine from damage and perform the actual crushing of the material. The two types of wear part are the mantle and a set of several bowl liners, particularly concave liners. The mantle is fixed to the main shaft, and the concave liners (or simply “concaves”) are fixed to the frame or topshell of the crusher. The concaves are arranged in several rows sitting on top of each other.

Wear parts may be made from chilled cast iron or from steel alloy, such as manganese steel, depending on the character of the material to be crushed and the particular class of service for which the machine is intended. Manganese steel combines extreme toughness with high wear resistance and has therefore developed into the universal choice for crushing hard, tough rock, even regardless of the class of service or the type of crusher. A common material is 12-14% manganese steel, also known as Hadfield steel. Different alloys have been used for liner segments in upper, middle and bottom parts of the crushing chamber.

Typically, both the mantle and the concaves wear and distort due to the significant pressures and impact loading forces they transmit. The wear parts are therefore changed at intervals. The duration of these intervals is influenced by several different factors, one factor being the wear profiles or wear patterns of both the mantle and the concaves. Avoiding undesired wear patterns can increase the lifetime of the mantles and concaves, thereby reducing shutdown costs.

EP 0 506 126 A1 describes, in its prior art section, a mantle (movable member) of a cone crusher. A plurality of grooves are formed on an outer peripheral surface of the mantle of frustoconical structure and extend in the same directions as that of a generating line of the mantle.

US 2008/0041995 A1 relates to a cone crusher with a crushing surface comprising a conical head and a concave bowl. At least one of the head or bowl comprises a segmented wear liner. The wear liner may comprise a plurality of wear resistant inserts.

### SUMMARY OF THE INVENTION

In view of the above, an object underlying the invention is to extend the lifetime of wear parts of a gyratory or cone crusher.

To achieve this object, the present invention provides a mantle for a gyratory or cone crusher as recited in claim 1.

The mantle comprises a central axis, a first end and a second end along the central axis, and an outer peripheral surface defined by a generatrix rotating around the central axis. An outer diameter of the mantle is larger at the second end than at the first end of the mantle. The outer peripheral surface constitutes a crushing surface of the mantle. According to the invention, one or more grooves are formed in the crushing surface at the second end of the mantle, and one or more cavities for receiving wear resistant inserts are formed in the crushing surface, and/or one or more wear resistant inserts are bonded to or into the crushing surface.

In the mantle of the invention, the combination of the grooves on the one hand and the wear resistant inserts on the other hand positively influences the wear profile of the mantle.

Turning first to the grooves, the grooves are provided to facilitate the discharge of finely crushed material from the crushing zone. The further the material to be crushed moves downwards within the crushing gap, the further the material is refined, and the less voids remain in between the pieces of material. Under certain circumstances, this may result in a choking of the crusher, i.e. an excessively packed state of material in a high density area near the narrowest part of the crushing gap. The grooves at the lower end of the mantle of the invention promote a discharge of the fines from the crushing gap and thereby reduce the risk of packing.

As to the shape and configuration of the grooves, it is particularly advantageous for the grooves to extend along the crushing surface generally in a direction from the second end towards the first end of the mantle. The grooves could run along straight or curved lines, substantially in a direction of a respective generatrix of the frame or at an angle thereto, or substantially parallel to the central axis of the mantle, as long as the extension of at least a part of each groove is generally towards the second, lower end of the mantle, to provide a path for the fines to leave the crushing gap.

For the same reasons, i.e. to allow for the fines to leave the crushing gap, it is advantageous for the grooves to open at the second end of the mantle, rather than having a closed bottom at the second mantle end.

In practical embodiments, the one or more grooves may be spaced at regular intervals in a circumferential direction of the crushing surface, thereby providing for a uniform mode of operation about the entire circumference of the rotationally symmetric mantle.

As to the shape of the grooves as such, the one or more grooves may each have e.g. a C-, U- or V-shape in a cross section perpendicular to the central axis, in particular the shape of a V with a rounded bottom. Alternatively or in addition, a width and/or a depth of each of the one or more grooves may increase towards the second end of the mantle.

In addition to the grooves, one or more cavities for receiving wear resistant inserts are formed in the crushing surface, and/or one or more wear resistant inserts are bonded to or into the crushing surface. This means that the mantle may be provided e.g. in a state in which the cavities have been formed in the crushing surface, but wear resistant inserts have not been inserted into the cavities yet; or e.g. in a state in which cavities have been formed in the crushing surface, and wear resistant inserts have been inserted into the cavities; or e.g. in a state in which wear resistant inserts have been bonded to the crushing surface without cavities being formed to receive the inserts. In the following, reference will therefore be made to the “cavities and/or inserts”.

The one or more cavities and/or wear resistant inserts may be formed in the crushing surface in various specific patterns depending on the individual application:

The cavities and/or inserts may be arranged in at least one row, in particular a circumferential row e.g. in a plane perpendicular to the central axis of the mantle, and/or in at least one column extending from the second end towards the first end of the mantle, in particular along a generatrix of the mantle.

One or more cavities and/or inserts of one row may be offset in a circumferential direction of the mantle against one or more cavities and/or inserts of another row.

One or more cavities and/or inserts of one column may be offset along a generatrix of the mantle with respect to one or more cavities and/or inserts of another column.

Irrespective of the specific pattern of cavities and/or inserts, the crushing surface may comprises a high wear section in an area between the first and second ends of the mantle in which the cavities and/or inserts are formed with a density which is higher than in at least one other section of the crushing surface.

A spacing of the cavities and/or inserts in one row may be wider than the spacing of the cavities and/or inserts of another row, in particular another row further towards the second end of the mantle. A wider spacing may result from a smaller number of cavities per row and/or from a wider diameter of the mantle. Alternatively or in addition, the spacing between adjacent cavities in a column may become wider towards the first end of the mantle. These measures may result in a denser spacing of the cavities in a high wear area near the second end of the mantle.

The one or more cavities and/or wear resistant inserts may also be arranged in various ways relative to the one or more grooves. For example, the cavities and/or inserts may be formed in the crushing surface between the one or more grooves as seen along an outer circumference of the mantle. One or more cavities and/or inserts may be aligned with each of the one or more grooves along a respective generatrix of the mantle. Areas along the crushing surface between the grooves and the first end of the mantle, and/or areas along the crushing surface between the grooves and the second end of the mantle, may also be devoid of cavities and/or inserts.

The wear resistant inserts may be bonded to or into the crushing surface in various ways. The inserts may be brazed, press fit, or otherwise bonded to or into the crushing surface of the mantle. The inserts may protrude out of the crushing surface to a certain extent, be flush with the crushing surface, or recessed from the crushing surface. In the latter case, the inserts may be embedded into the crushing surface so that when the mantle is new, the surfaces of the inserts are set back from the crushing surface. Once the mantle wears, the inserts become exposed since they are harder than the surrounding material. In still other embodiments, no cavities are formed, and the inserts are bonded to the crushing surface.

The mantle of the invention may constitute a single mantle for a gyratory or cone crusher. The mantle of the invention may also be configured as a lower mantle for being connected with an upper mantle, with the upper and lower mantles being aligned along a central axis.

The invention further provides a mantle for a gyratory or cone crusher, wherein the mantle comprises a lower mantle and an upper mantle configured to be connected and aligned along a central axis, wherein the lower mantle is a mantle as described above.

Finally, the invention also provides a gyratory or cone crusher comprising a frame provided with a bowl as a first crushing shell, and a crusher head provided with a mantle as a second crushing shell, wherein the mantle and bowl define a crushing gap between them, and wherein the mantle configured as described above.

In all embodiments of the invention, the generatrix defining the outer peripheral surface of the mantle by rotating around the central axis could be a straight line, resulting in an essentially frustoconical shape of the mantle, or the generatrix could be at least partially curved, resulting in the crushing surface of the mantle being at least partially concave and/or at least partially convex.

### BRIEF DESCRIPTION OF THE DRAWINGS

The above, as well as additional objects, features and advantages of the present invention will be better understood through the following illustrative and non-limiting detailed description of preferred embodiments of the present invention, with reference to the appended drawings, where the same reference numerals will be used for similar elements, wherein:

FIG. 1 shows a first embodiment of a mantle according to the present invention,

FIG. 2 shows a second embodiment of a mantle according to the present invention,

FIG. 3 shows a third embodiment of a mantle according to the present invention,

FIG. 4 is a detailed view of a part of the outer crushing surface of the mantle of FIG. 3,

FIG. 5 is a partial top view of the mantle of FIG. 3,

FIG. 6 is a longitudinal cross-sectional view of a part of the mantle of FIG. 3 and an associated bowl,

FIG. 7 shows a fourth embodiment of a mantle according to the present invention,

FIG. 8 is a partial top view of the mantle of FIG. 7,

FIG. 9 is a partial side view of the mantle of FIG. 7,

FIG. 10 shows a fifth embodiment of a mantle according to the present invention,

FIG. 11 shows a sixth embodiment of a mantle according to the present invention,

FIG. 12 shows schematically a cone crusher and a gyratory crusher of the prior art,

FIG. 13 shows an exemplary mantle of a gyratory crusher in cross section that is having a bell shape; and

FIG. 14 shows an exemplary wear pattern of a concave and a mantle of a gyratory crusher of the prior art in cross section.

### DETAILED DESCRIPTION OF PREFERRED EMBODIMENTS

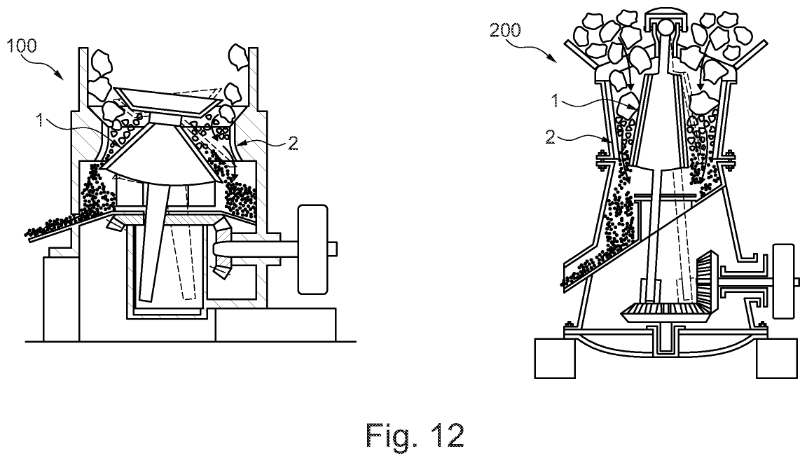

FIG. 12 schematically illustrates a previously known cone crusher 100 and a previously known gyratory crusher 200 in longitudinal cross sections.

In the cone crusher 100 and the gyratory crusher 200, an inner crushing shell, also designated a mantle 1, is mounted on a crusher head of the crusher. An outer crushing shell, also designated a bowl 2, is mounted on a frame of the crusher. The mantle 1 and the bowl 2 constitute wear parts which have to be exchanged from time to time. In larger gyratory crushers, the bowl 2 is often made up from segments, also called concaves due to their shape, which are arranged in one or several annular rows.

A crushing chamber or crushing gap is formed between the mantle 1 and the bowl 2. When the crusher 100/200 is operated, material to be crushed is introduced into the crushing gap and is crushed between the mantle 1 and the bowl 2 as a result of the gyrating movement of the crusher head, during which movement the mantle 1 approaches the bowl 2 along a rotating generatrix and moves away therefrom along a diametrically opposed generatrix.

During this crushing operation, significant forces are exerted upon the mantle 1 and the bowl 2, resulting in a significant wear of these wear parts.

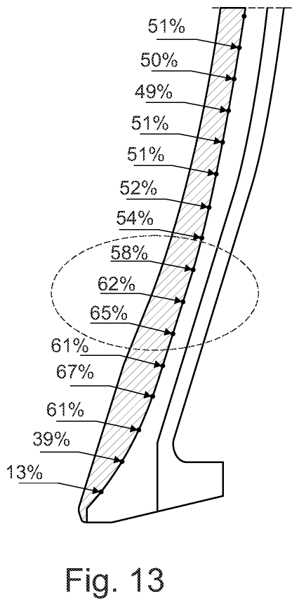

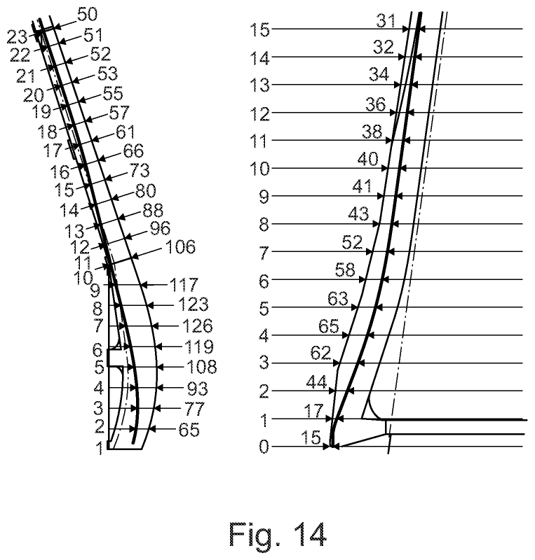

FIG. 13 shows a part of the lower end of a mantle in cross section wherein the area in which the most significant forces are created during operation is marked with a dashed oval. The wear pattern of the mantle is indicated in the Figure, and it is apparent that the crushing surface of the mantle wears away so as to assume a bell shape.

FIG. 14 shows a part of a concave and a mantle in cross section wherein the wear patterns of the concave and mantle are indicated. The mantle displays a typical wear pattern that leaves a “dish” in the parallel zone of the mantle just above the bottom edge, whereas the very bottom edge does not wear as much. The resulting worn portion of the mantle has a bell-shaped profile like in FIG. 13.

The mantle of the present invention is designed to avoid undesired, non-uniform wear patterns of the mantle and bowl of a cone crusher or a gyratory crusher.

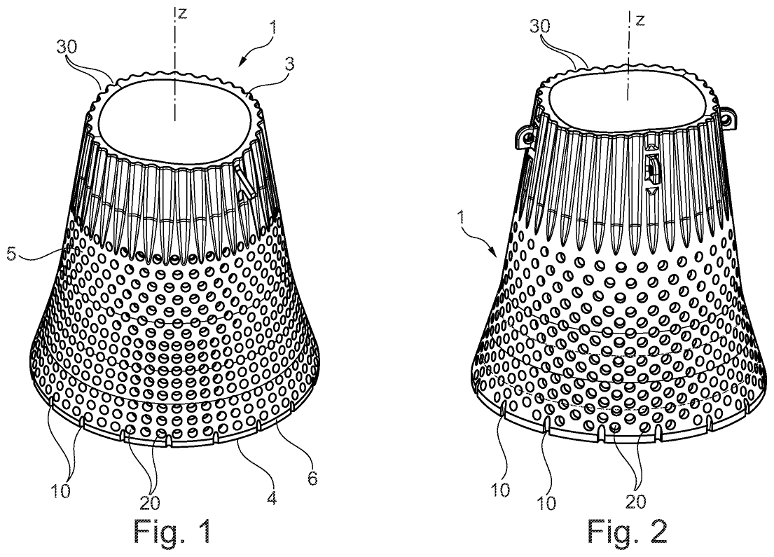

FIG. 1 shows a first embodiment of a mantle 1 according to the present invention. The mantle 1 comprises a central axis Z; a first, upper end and a second, lower end along the central axis Z; and an outer peripheral surface constituting a crushing surface 5 of the mantle.

While the shape of the mantle 1 is essentially that of a truncated cone, the crushing surface 5 is slightly concave as seen along a generatrix of the mantle, in particular near the lower end of the mantle 1. The resulting slightly increased bottom diameter of the mantle, compared to a purely frustoconical shape, contributes to ensuring the required lifetime of the mantle.

Two features are provided in order to promote a desired wear pattern of the crushing surface 5 of the mantle: on the one hand, a series of grooves 10 at a lower circumferential edge 4 of the crushing surface 5 of the mantle, and on the other hand, a number of cavities 20 for wear inserts which are distributed across the crushing surface 5 of the mantle.

The grooves 10 at the lower circumferential edge 4 extend along the crushing surface 5 generally in a direction from the lower end towards the upper end of the mantle and are open at the lower end of the mantle to provide a path for fines to leave the crushing gap. This reduces power spikes as well as the risk of packing, or “choking”, of the crusher.

The wear shape of the mantle I can also be controlled by allowing the fines to pass; in particular, an undesired bell shape of the mantle as well as a phenomenon known as “cupping” can be reduced.

Avoiding a poor wear profile of mantle, power spikes and packing in turn reduces production losses and mechanical failures and provides for a longer lifetime of the mantle.

In this embodiment, the grooves 10 are spaced apart in regular intervals along the lower circumferential edge 4 of the crushing surface 5 of the mantle.

Each groove 10 has a generally vertical extension, i.e. an extension generally parallel to the central axis Z of the mantle.

While the vertical extension of the grooves 10 in this embodiment is relatively short, the groove length may vary depending on the specific application.

The cavities 20 are provided to accommodate wear resistant inserts which will be described in more detail below. The cavities 20, and therefore the inserts accommodated therein, are arranged in a pattern relative to one another and relative to the grooves 10 which is chosen depending on the individual application. The various patterns according to the present disclosure have been designed in view of the wear patterns observed with conventional mantles.

In the illustrated embodiment, the cavities are aligned about the lower portion of the crushing surface 5 in a matrix made up from rows and columns, with the rows running along the circumference of the mantle 1 and the columns extending from the second, lower end 4 towards the first, upper end 3 of the mantle. In the present embodiment, the rows run in respective planes perpendicular to the central axis of the mantle, whereas the columns follow respective generatrices. In this and other embodiments, the extension of the rows and/or the columns could also deviate from these specific directions, though, resulting in e.g. spiral alignments of cavities 20.

The cavities 20 are formed in the crushing surface 5 between the grooves 10 as seen along an outer circumference of the mantle 1. The cavities 20 are aligned along respective generatrices of the mantle 1. In the present embodiment, the lower portion of the mantle includes a total of eight circumferential rows of cavities, and three columns of cavities are provided between two adjacent grooves as seen in the circumferential direction of the mantle. Areas above the grooves 10 are devoid of cavities 20 in this lower portion of the mantle.

In an area above the lower portion of the mantle, further cavities 20 are aligned in rows along the circumference, wherein the spacing between adjacent cavities in the circumferential direction is wider than in the lower portion, and wherein the cavities in one circumferential row are offset in the circumferential direction relative to the cavities in an adjacent row. This results in the cavities in the lower portion generally forming a denser pattern than in the upper portion. On the other hand, considering that the circumference of the mantle becomes wider towards its lower edge, the highest concentration of inserts is in an area of the mantle between the first and second ends. This is also the area subject to the most excessive wear. Providing the highest concentration of inserts in the area of maximum wear aims to optimize the mantle's wear life and to provide for an optimal wear shape.

As already described above, the vertical extension of the grooves 10 in this embodiment is relatively short. In fact, the grooves 10 only extend from the second end of the mantle 1 towards the lowermost row of cavities 20.

At the lower edge 4 of the mantle 1, an annular portion 6 of the crushing surface 5 is formed so as to extend substantially parallel to the central axis Z. This annular edge portion 6 is free from any cavities 20 for wear resistant inserts. The grooves 10 are formed to cross this annular edge portion 6 though.

The mantle's upper section is provided with longitudinal grooves 30 in order to break large boulders with less force and to compensate for deformations (Mn growing) in the top section which are prone to occur over time.

FIG. 2 shows a second embodiment of a mantle according to the present invention.

The mantle of this embodiment is similar to the one in FIG. 1 insofar as its general shape and also the shape and arrangement of the grooves 10 at the circumference of the mantle are concerned.

The mantle in FIG. 2 differs from the one in FIG. 1 in the location of the cavities 20, both in absolute terms and relative to the grooves 10: in FIG. 2, the cavities are aligned in circumferential rows and in columns following respective generatrices. The vertical extension of the grooves 10 in this embodiment is again relatively short, and the grooves 10 only extend from the second end of the mantle 1 towards the lowermost row of cavities 20. However, other than in FIG. 1, a column of cavities is also positioned directly above each groove. Also, across the crushing surface 5, the cavities in one row are offset in a circumferential direction relative to the cavities in adjacent rows, and the cavities in one column are offset as seen along the generatrices relative to the cavities in adjacent columns.

In each of the columns, the spacing between adjacent cavities becomes wider towards the upper end of the mantle. This again results in the highest concentration of inserts in this embodiment being in a high wear area of the mantle (marked with dashed lines in FIG. 2) to control the wear shape and provide maximum lifetime.

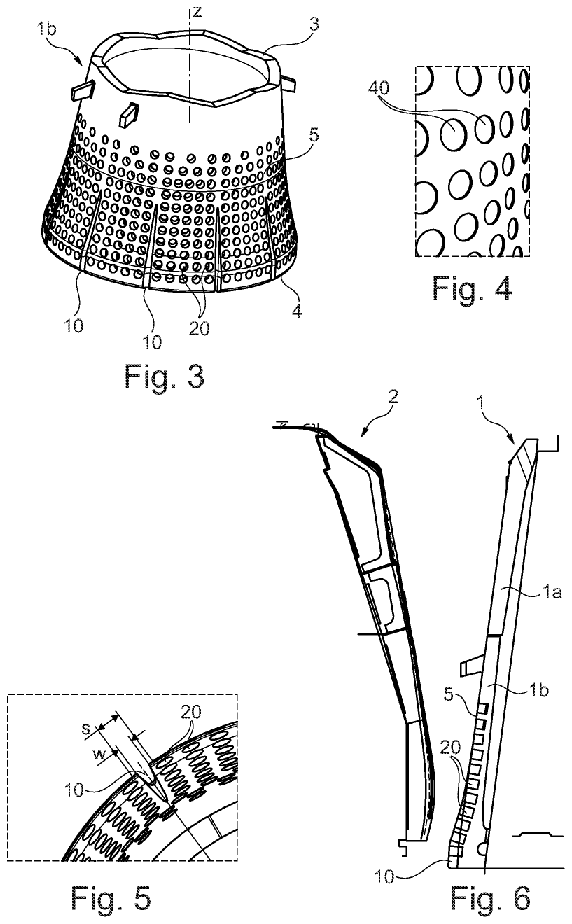

FIG. 3 shows a mantle according to a third embodiment of the present invention. In this embodiment, an upper mantle section or “upper mantle” 1a and a lower mantle section or “lower mantle” 1b are aligned along the central axis Z of the mantle (see also FIG. 6). The mantle in FIG. 3 is the lower mantle 1b, and it comprises the grooves 10 and cavities 20 for inserts in accordance with the present invention.

A total of eleven grooves 10 is provided in this embodiment.

The cavities 20 are arranged in a matrix of circumferential rows and columns without any offset between the cavities 20 in adjacent rows and columns, with the exception of the uppermost two circumferential rows. No cavities 20 are formed in the areas directly above the grooves 10. Similar as in the first and second embodiments, the spacing of the cavities 20 is tightest in a high wear area, preventing cupping. Near the lower edge of the mantle 1b, the spacing between adjacent cavities 20 is wider. Near the upper end of the mantle 1b, the rows of cavities comprise a smaller number of cavities 20, resulting in a larger spacing between adjacent cavities 20 also in this upper area.

A proper spacing of the cavities 20 relative to the grooves 10 at the lower circumference can control the width and formation of the grooves 10 during the life of the mantle and therefore impact the size of the material that is discharged from the crusher while relieving pressure in the crushing cavity and reducing power spikes specifically towards the end of the mantle's lifetime as a wear part. In the embodiment of FIG. 3, the grooves 10 extend from the lower edge 4 at the second end of the mantle 1b through several rows of cavities 20. Also, in this embodiment, a circumferential width of the groove 10 increases towards the lower edge 4 of the mantle 1b.

FIG. 4 is a detailed view of a portion of the crushing surface 5 of the mantle 1b in FIG. 3 in a state in which wear resistant inserts 40 have been fixed in the cavities.

The inserts 40 are disposed in such a way to provide optimal disintegration of crushing material while also providing enhanced wear resistance for the replaceable mantle 1b.

The following description of the inserts 40 applies to this and all other embodiments of the invention.

The inserts 40 may comprise a solid material or a combination of materials. In an example, the inserts comprise a base formed of cemented metal carbide substrate with a super hard material bonded to it forming a tip. The tip may comprise a coating of super hard material, e.g. diamond, diamond impregnated carbide, cemented metal carbide, chromium, titanium, aluminum, tungsten, and combinations thereof.

The inserts 40 may be brazed, press fit, or otherwise bonded to or into the crushing surface 5 of the mantle, such as into the cavities 20 previously described. The inserts 40 may protrude out of the crushing surface 5 to a certain extent, depending on the material to be reduced. In some embodiments the inserts 40 do not protrude from the crushing surface 5 but are flush with the crushing surface 5, or recessed from the crushing surface 5: In the latter case, the inserts 40 may be embedded into the crushing surface 5 so that when the mantle is new, the surfaces of the inserts 40 are set back (e.g. by 1-3 mm) from the crushing surface 5. Once the mantle wears, the inserts 40 become exposed since they are harder than the surrounding material. In still other embodiments, no cavities are formed, and the inserts 40 are simply bonded to the crushing surface 5.

Various insert geometries may be used. Each geometry may be advantageous depending on the material and application of the mantle 1. Where the inserts 40 have a circular shape as shown in FIG. 4, a diameter of the inserts 40 may e.g. range from 1 mm to 150 mm. Another exemplary shape of the inserts 40 is an oval shape, e.g. having a length of 120 or 130 mm.

These inserts 40 may be bonded or otherwise attached to any portion of the mantle 1, although they are preferably attached to at least the lower portion of the mantle 1 where it is most prone to wear.

Additionally, some applications of the invention may favour specific insert placements patterns and densities at specific circumferences of the crushing surface 5 of the mantle 1. Exemplary patterns are described above and below for the individual embodiments. In principle, any combination of insert densities and insert placement patterns may be used for any mantle 1 according to the invention.

FIG. 5 is a partial top view of the mantle 1b of FIG. 3. It is apparent from this view that the circumferential width of the groove 10 also increases in the radially outward direction of the mantle 1b, from a bottom of the groove 10 towards the crushing surface 5 of the mantle 1b so that the groove 10 has the shape of a V with a rounded bottom in this top view and also in a cross section perpendicular to the central axis. The maximum width of the groove 10 at the lower edge 5 of the mantle 1b is indicated “w”. The spacing between the cavities 20 to either side of the groove 10 in the circumferential direction is indicated “s”. Locating the inserts close to the groove 10 can limit the extent to which the groove 10 is able to expand during operation. In a specific example, the groove width 10 is 61 mm, and the maximum depth of the groove (as seen from the crushing surface 5 in a radially inward direction) is 78 mm.

FIG. 6 is a partial longitudinal cross section of a mantle 1 according to this third embodiment and of a bowl 2, comprising an arrangement of concaves, which forms a crushing chamber together with the mantle 1. The shape and location of one of the grooves 10 and of a column of cavities 20 is apparent from the Figure. In this and other embodiments, the depth of the cavities 20 (i.e. the extent to which the cavities 20 penetrate into the substrate of the mantle 1 from the crushing surface 5) is reduced for cavities 20 in upper rows compared to cavities 20 in lower rows towards the lower edge 4 of the mantle 1. Also, the depth of the groove 10 is smaller than the depth of the cavities 20 in at least the lowermost row or rows of cavities 20.

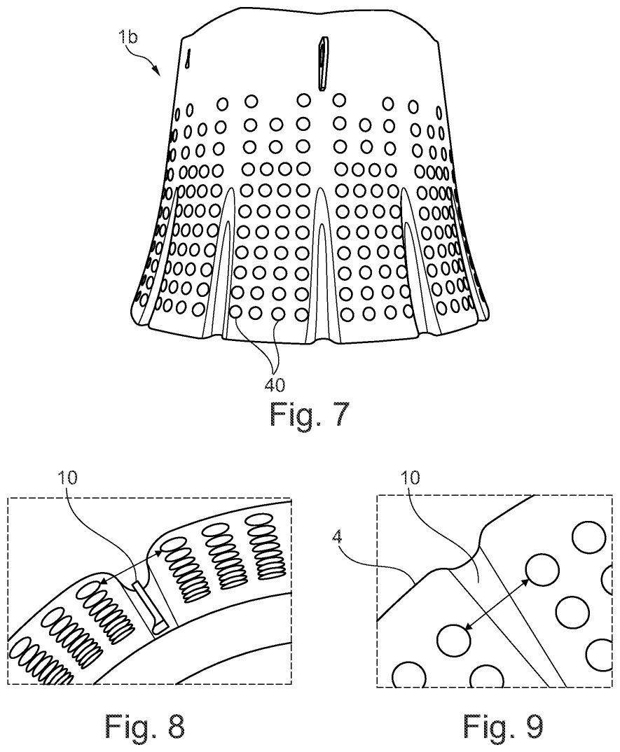

FIG. 7 shows a mantle 1b according to a fourth embodiment of the present invention. The mantle 1b is illustrated here in a used state: after a certain operational period during which the mantle 1b has been subject to wear, the transitions from the grooves 10 towards the crushing surface 5 of the mantle 1b have assumed a more rounded shape. This is particularly apparent from FIG. 8, showing a top view of the mantle in FIG. 7, and from FIG. 9, showing a side view of the mantle 1b in FIG. 7 in the area of one of the grooves 10 at the lower edge 4 of the mantle.

The cavities 20 and the inserts 40 placed therein are arranged in a matrix of rows and columns without any offset between the cavities 20 in adjacent rows and columns, with the exception of the uppermost three rows. No cavities 20 are formed in the areas directly above the grooves 10.

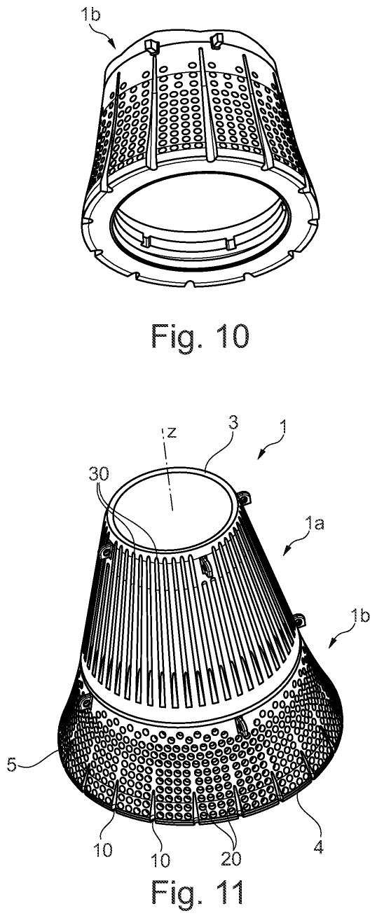

FIG. 10 shows a mantle 1b according to a fifth embodiment of the present invention which is again configured to be used as a lower mantle 1b. The location of the cavities 20 across the crushing surface 5 of this mantle 1b is similar as in the mantle 1b of FIGS. 7-9. The mantle 1b in FIG. 10 is in a state prior to wear, though, and therefore the shape of the grooves in a horizontal cross section (i.e. a cross section in a plane perpendicular to the axis Z of the mantle 1b) is similar as in the embodiment of FIGS. 3-6, i.e. the transitions between the grooves 10 and the crushing surface 5 are still edged. Also, in this brand new state of the mantle 1b, the grooves 10 extend from the second end 4 towards the first end 3 of the mantle 1b beyond all of the rows of cavities 20 in the embodiment of FIG. 10.

Finally, FIG. 11 shows a sixth embodiment of a mantle 1 according to the present invention. In this embodiment, the mantle 1 is comprised of an upper mantle la and a lower mantle 1b aligned along the mantle's central axis Z. The upper mantle la is unchanged compared to upper mantles or mantle sections of conventional two-piece mantles; it is provided with longitudinal grooves 30 in order to break large boulders with less force and to compensate for deformations (Mn growing) in the top section which are prone to occur over time. The lower mantle 1b is configured in accordance with the present invention and comprises the grooves 10 at the lower edge thereof, as well as the cavities 20 for inserts across the crushing surface 5 thereof.

While several specific embodiments of the invention have been described above, the scope of the invention is not restricted thereby, and various modifications are possible within the scope of the invention as defined by the appended claims. For example, while the above embodiments are configured so that all of the grooves 10 of a mantle 1, 1b have the same shape, it would equally be possible to distribute grooves with different sizes and shapes along the lower circumference of a mantle 1, 1b. The same can be said for the cavities 20 and/or inserts 40, i.e. the cavities 20 and/or inserts 40 of a mantle 1, 1b of the invention could have different sizes and shapes e.g. in individual areas of the crushing surface 5.

1. A mantle for a gyratory or cone crusher,
the crusher comprising a frame provided with a bowl as a first crushing shell, and a crusher head provided with the mantle as a second crushing shell, wherein the mantle and bowl define a crushing gap between them,
wherein the mantle comprises a central axis, a first end and a second end along the central axis, and an outer peripheral surface defined by a generatrix rotating around the central axis, the outer peripheral surface constituting a crushing surface of the mantle, and an outer diameter of the mantle being larger at the second end than at the first end of the mantle,
wherein one or more grooves are formed in the crushing surface at the second end of the mantle, and
wherein one or more cavities for receiving wear resistant inserts are formed in the crushing surface, and/or one or more wear resistant inserts are bonded to or into the crushing surface.

2. The mantle for a gyratory or cone crusher according to claim 1, wherein the one or more grooves extend along the crushing surface generally in a direction from the second end towards the first end of the mantle.

3. The mantle for a gyratory or cone crusher according to claim 1, wherein the one or more grooves are spaced at regular intervals in a circumferential direction of the crushing surface.

4. The mantle for a gyratory or cone crusher according to claim 1, wherein the one or more grooves are open at the second end of the mantle.

5. The mantle for a gyratory or cone crusher according to claim 1, wherein the one or more grooves extend substantially along respective generatrices of the crushing surface or substantially parallel to the central axis of the mantle.

6. The mantle for a gyratory or cone crusher according to claim 1, wherein the one or more grooves each have a C-, U- or V-shape in a cross section perpendicular to the central axis, in particular the shape of a V with a rounded bottom.

7. The mantle for a gyratory or cone crusher according to claim 1, wherein a width and/or a depth of each of the one or more grooves increases towards the second end of the mantle.

8. The mantle for a gyratory or cone crusher according to claim 1, wherein the one or more cavities and/or wear resistant inserts are formed in the crushing surface between the one or more grooves as seen along an outer circumference of the mantle.

9. The mantle for a gyratory or cone crusher according to claim 1, wherein one or more cavities and/or wear resistant inserts are formed in the crushing surface in at least one row, in particular a circumferential row, e.g. in a plane perpendicular to the central axis.

10. The mantle for a gyratory or cone crusher according to claim 9, wherein one or more cavities and/or inserts of one row are offset in a circumferential direction of the mantle against one or more cavities and/or inserts of another row.

11. The mantle for a gyratory or cone crusher according to claim 9, wherein a spacing of the cavities and/or inserts in one row is wider than the spacing of the cavities and/or inserts of another row, in particular another row further towards the second end of the mantle.

12. The mantle for a gyratory or cone crusher according to claim 1, wherein one or more cavities and/or inserts are formed in the crushing surface in at least one column extending from the second end towards the first end of the mantle, in particular along a generatrix of the mantle.

13. The mantle for a gyratory or cone crusher according to claim 12, wherein one or more cavities and/or inserts of one column are offset along a generatrix of the mantle with respect to one or more cavities and/or inserts of another column.

14. The mantle for a gyratory or cone crusher according to claim 12, wherein the spacing between adjacent cavities in a column becomes wider towards the first end of the mantle.

15. The mantle for a gyratory or cone crusher according to claim 1, wherein the crushing surface comprises a high wear section in an area between the first and second ends of the mantle in which the cavities and/or inserts are formed with a density which is higher than in at least one other section of the crushing surface.

16. The mantle for a gyratory or cone crusher according to claim 1, wherein areas along the crushing surface between the grooves and the first end of the mantle are devoid of cavities and/or inserts, and/or areas along the crushing surface between the grooves and the second end of the mantle are devoid of cavities and/or inserts.

17. The mantle for a gyratory or cone crusher according to claim 1, wherein one or more cavities and/or inserts are aligned with each of the one or more grooves along a respective generatrix of the mantle.

18. The mantle for a gyratory or cone crusher according to claim 1, wherein the mantle is configured as a lower mantle for being connected with an upper mantle, with the upper and the lower mantle being aligned along a central axis.

19. A mantle for a gyratory or cone crusher, wherein the mantle comprises a lower mantle and an upper mantle configured to be connected and aligned along a central axis, wherein the lower mantle is a mantle according to claim 1.

20. A gyratory or cone crusher comprising a frame provided with a bowl as a first crushing shell, and a crusher head provided with a mantle as a second crushing shell, wherein the mantle and bowl define a crushing gap between them, and wherein the mantle is in accordance with claim 1.
